(19) United States
(12) Patent Application Publication
(10) Pub. No.: US 2025/0045993 A1
(43) Pub. Date: Feb. 6, 2025

(54) IMAGE GENERATING APPARATUS, VIRTUAL FITTING SYSTEM, IMAGE GENERATING METHOD, AND STORAGE MEDIUM

(71) Applicant: CANON KABUSHIKI KAISHA, Tokyo (JP)

(72) Inventor: Mai NAKABAYASHI, Tokyo (JP)

(21) Appl. No.: 18/769,516

(22) Filed: Jul. 11, 2024

(30) Foreign Application Priority Data
Aug. 2, 2023 (JP) 2023-126352

(51) Int. Cl. G06T 11/60; G06T 7/60

(52) U.S. Cl. CPC G06T 11/60; G06T 7/60; G06T 2207/20076; G06T 2207/20081; G06T 2207/30196; G06T 2210/16

(57) ABSTRACT

An image generating apparatus includes a memory storing instructions, and a processor configured to execute the instructions to compare a future body size of a person and a clothing size, and change a scale of at least one of a clothing image and a person image, and generate a virtual fitting image by superimposing the clothing image on the person image.

### BACKGROUND

### Technical Field

One of the aspects of the embodiments relates to an image generating apparatus, a virtual fitting system, an image generating method, and a storage medium.

### Description of Related Art

When a customer considers purchasing clothing for her child, she wants her child to try it on to determine whether it fits the child's body or whether it looks good. Since it takes time and effort to actually try a plurality of clothes on, the customer may feel arduous. In addition, in purchasing clothing for her child, the customer may estimate how long her child can wear it and use the estimation for the purchase.

A virtual fitting system has conventionally been known that displays to a customer who is considering purchasing clothing a virtual fitting state of that clothing, and assists the customer in making a selection.

Japanese Patent Laid-Open No. 2022-106923 discloses an image generating apparatus configured to generate a clothing image having a scale that has been adjusted according to the body size (dimension) of a person's body image, and to display a combined image in which the clothing image is superimposed on the person's body image.

However, the image generating apparatus disclosed in Japanese Patent Laid-Open No. 2022-106923 does not enable the user to visually confirm a future “fitting state” of the child although he can confirm the current “fitting state” of her child.

### SUMMARY

An image generating apparatus according to one aspect of the disclosure includes a memory storing instructions, and a processor configured to execute the instructions to compare a future body size of a person and a clothing size, and change a scale of at least one of a clothing image and a person image, and generate a virtual fitting image by superimposing the clothing image on the person image. A virtual fitting system including the above image generating apparatus also constitutes another aspect of the disclosure. An image generating method corresponding to the above image generating apparatus also constitutes another aspect of the disclosure. A storage medium storing a program that causes a computer to execute the above image generating method also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are block diagrams of a virtual fitting system according to this embodiment.

FIG. 2 is a schematic diagram illustrating a result estimated by a body part estimator according to this embodiment.

FIG. 3 is a flowchart illustrating a processing procedure of future body size acquiring unit according to this embodiment.

FIGS. 4A and 4B are schematic diagrams of a body size that is for processing in a body size acquiring unit according to this embodiment.

FIG. 5 is a flowchart illustrating a processing procedure of the future body size acquiring unit in a case where a past body size is used according to this embodiment.

FIG. 6 explains processing in an image adjuster according to this embodiment.

FIG. 7 explains processing in an image generator according to this embodiment.

FIG. 8 is a flowchart illustrating the processing procedure of a virtual fitting system according to this embodiment.

FIGS. 9A and 9B are schematic diagrams of virtual fitting images according to this embodiment.

FIGS. 10A and 10B are schematic diagrams of virtual fitting images in Examples 1 and 2.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

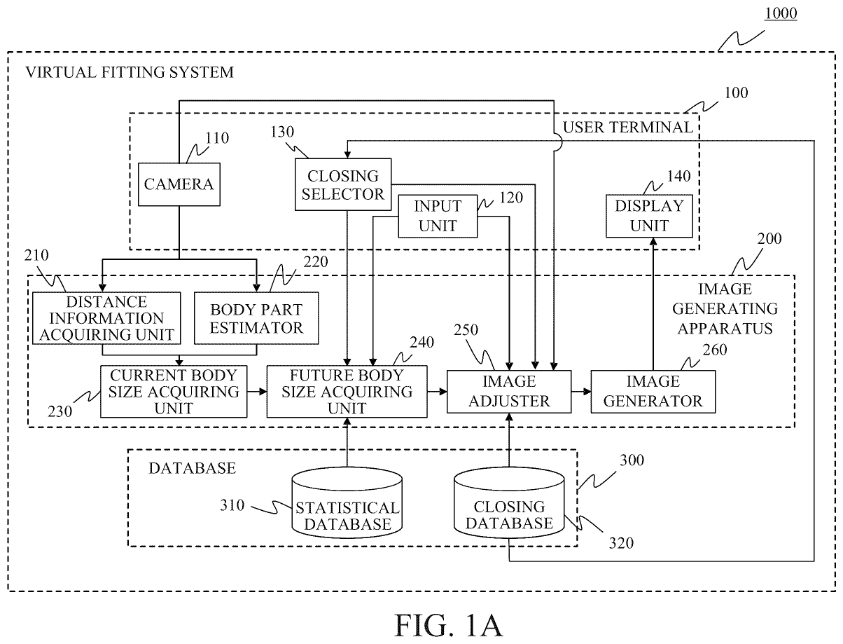

Referring now to FIGS. 1A and 1, a description will be given of the configuration of a virtual fitting system 1000 according to this embodiment. FIG. 1A is a block diagram illustrating the overall configuration of a virtual fitting system 1000. The virtual fitting system 1000 includes a user terminal 100, an image generating apparatus 200, and a database 300.

The database 300 includes a clothing database 320 configured to store data on a plurality of clothing images, a different size of each clothing image, and a clothing size for each size, and a statistical database 310 including a probability distribution of each of men and women from birth to the predetermined age. This embodiment sets the predetermined age, for example, to 20 years old, and the statistical database 310 stores data on a body size (dimension) up to the age at which a child approximately stops growing. In this embodiment, the clothing size refers to at least one of the criteria for measuring the closing size, such as (closing) length, sleeve length, inseam, chest circumference, girth, and waist circumference. This embodiment provides the clothing database 320 in which the above clothing size is recorded for each clothing.

The user terminal 100 includes a camera (image pickup apparatus) 110, an input unit 120, a clothing selector 130, and a display unit 140. The camera 110 captures a person as an object based on a user's instruction, and outputs an image of the object person obtained through imaging. The input unit 120 includes an operation unit configured to accept input from the user. In the clothing selector 130, the user selects one of the plurality of clothing images in the clothing database 320, and selects one size for the selected clothing image. The display unit 140 displays a virtual fitting image generated by an image generator 260, which will be described later. The camera 110 may image as the object a person different from the user, or may image the user himself as the object.

The image generating apparatus 200 includes a distance information acquiring unit 210, a body part estimator 220, a current body size acquiring unit 230 of the object person, a future body size acquiring unit 240 of the object person, an image adjuster 250, and an image generator 260. The distance information acquiring unit 210 acquires three-dimensional distance information on the object person based on the object person image captured by the camera 110 and the imaging information. The body part estimator 220 estimates a plurality of body parts of the object person in the object person image. In this embodiment, the body part includes at least one of the head, shoulder, hand, waist, crotch, or sole of the foot, but is not limited to them. The current body size acquiring unit 230 acquires the current body size of the person. A method for acquiring the current body size includes a calculating method using a plurality of body parts estimated by the body part estimator 220 and three-dimensional distance information on the object person acquired by the distance information acquiring unit 210, but the method is not limited to this example.

FIG. 1B is a block diagram partially illustrating the input unit 120, the future body size acquiring unit 240, the image adjuster 250, and the statistical database 310. The input unit 120 includes a predicted year and month input unit 121, a current body size input unit 122 of the object person, an age input unit 123, a gender input unit 124, a past body size input unit 125, and a future body size input unit 126, and a premature birth information input unit 127.

The predicted year and month input unit 121 inputs the year and month at which the growth of the object person is to be predicted. The current body size input unit 122 receives the current body size of the object person inputted by the user. In the age input unit 123 and the gender input unit 124, the user inputs the age and gender of the object person, respectively. In this embodiment, the age may include months. The past body size input unit 125 is configured to allow the user to input at least one combination of the past body size and age at that time of the object person. In the future body size input unit 126, the user inputs any body size (future body size). In the premature birth information input unit 127, the user inputs whether or not the object person is a premature baby, and if so, the expected date of delivery.

In this embodiment, the future body size acquiring unit 240 estimates the body size (future body size) of the object person after the predicted years and months have passed using at least one of two methods. One method is to estimate the future body size using the current body size, the age and predicted year and month obtained from the input unit 120, and the probability distribution of the body size of the object's gender obtained from the gender input unit 124. The current body size may be the current body size calculated by the current body size acquiring unit 230 or the current body size acquired from the current body size input unit 122. The other method is to estimate the future body size using, in addition to the current body size, the past body size acquired from the past body size input unit 125 and the age at that time.

The image adjuster 250 determines the scale of at least one of the clothing image and the object person image based on a comparison result of the future body size and the clothing size of the clothing image size selected by the user in the clothing selector 130. The future body size may be the future body size estimated by the future body size acquiring unit 240, or may be the future body size acquired from the future body size input unit 126. The image generator 260 generates a virtual fitting image by superimposing the clothing image on the person image based on the body parts estimated by the body part estimator 220. In this embodiment, the current body size and the future body size are at least one of height, sleeve length, back length, inseam, chest circumference, girth, and waist circumference, but the disclosure is not limited to this example.

A description will now be given of details of the individual blocks in FIGS. 1A and 1B. The distance information acquiring unit 210 acquires three-dimensional distance information on the object person from the image captured by the camera 110 and imaging information. Although the details of the acquiring method are not specified, for example, a method of estimating a three-dimensional distance of an object person using machine learning. For example, this can be realized by using an input value, such as still and moving images captured by the camera 110, an optical flow determined from these images, and sensor information such as a gyro sensor and an acceleration sensor in the camera 110. Estimation is possible by using a learning device trained with a model whose output value is three-dimensional distance information on the object. Alternatively, the method may use a defocus amount obtained from a focus detector in the camera 110, or three-dimensional distance information from a sensor such as a Light Detection and Ranging (LiDAR) sensor or a Time of Flight (ToF) sensor installed in the user terminal 100. Alternatively, a compound-eye camera may be used as the camera 110 to obtain three-dimensional distance information on the object person from the triangulation result.

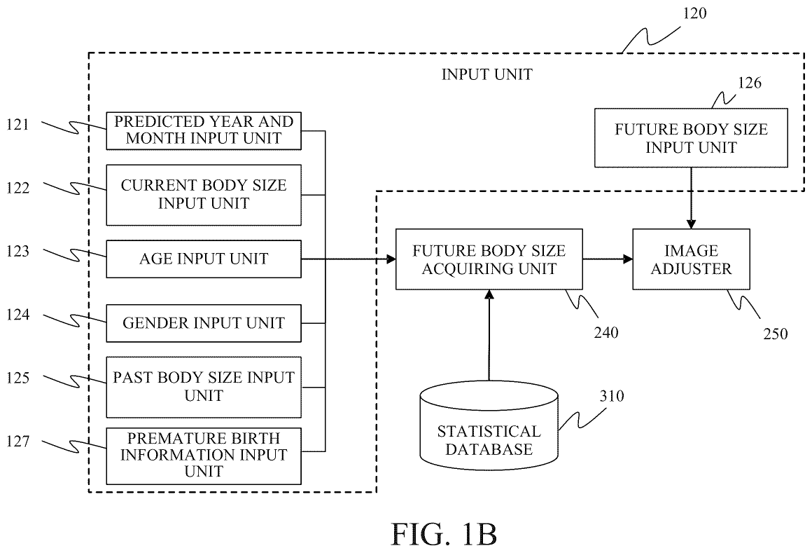

Referring now to FIG. 2, a description will be given of the body part estimator 220. FIG. 2 is a schematic diagram illustrating the result estimated by the body part estimator 220, and illustrates the body parts of the object person. The body part estimator 220 estimates a plurality of body parts of the object person in the object person image. For example, a method of estimating a body part using a machine learning device by setting a human image as an input value and a body part as an output value can be considered, but the method is not limited to this example. In this embodiment, as illustrated in FIG. 2, the body part estimator 220 estimates the positions of the head, shoulders, hands, waist, crotch, and soles in the human object image.

The current body size acquiring unit 230 calculates the current body size from the plurality of estimated body parts and three-dimensional distance information on the object person. For example, the height, which is the current body size, is calculated from the distance information from the head of the object person to the soles of the feet.

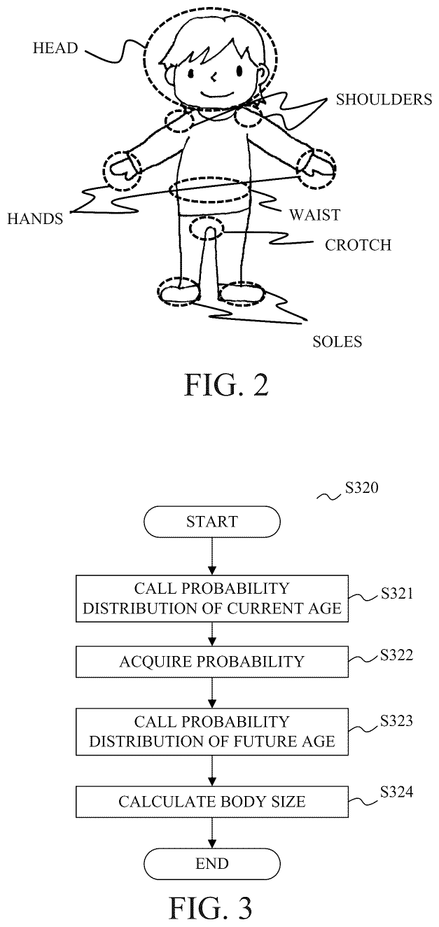

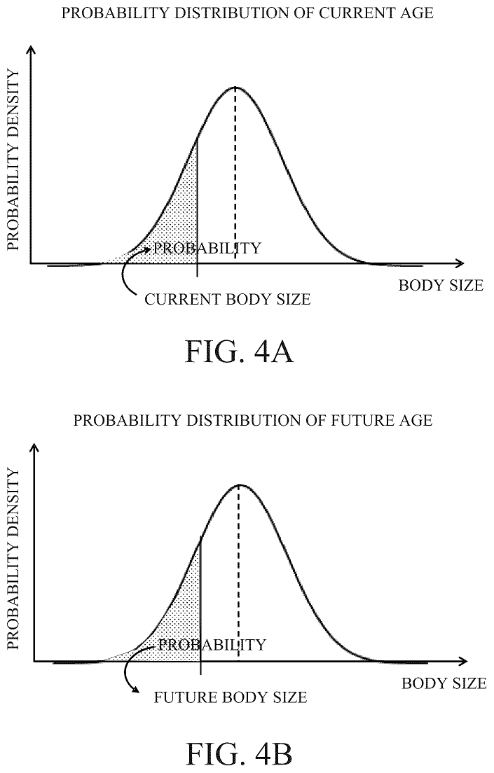

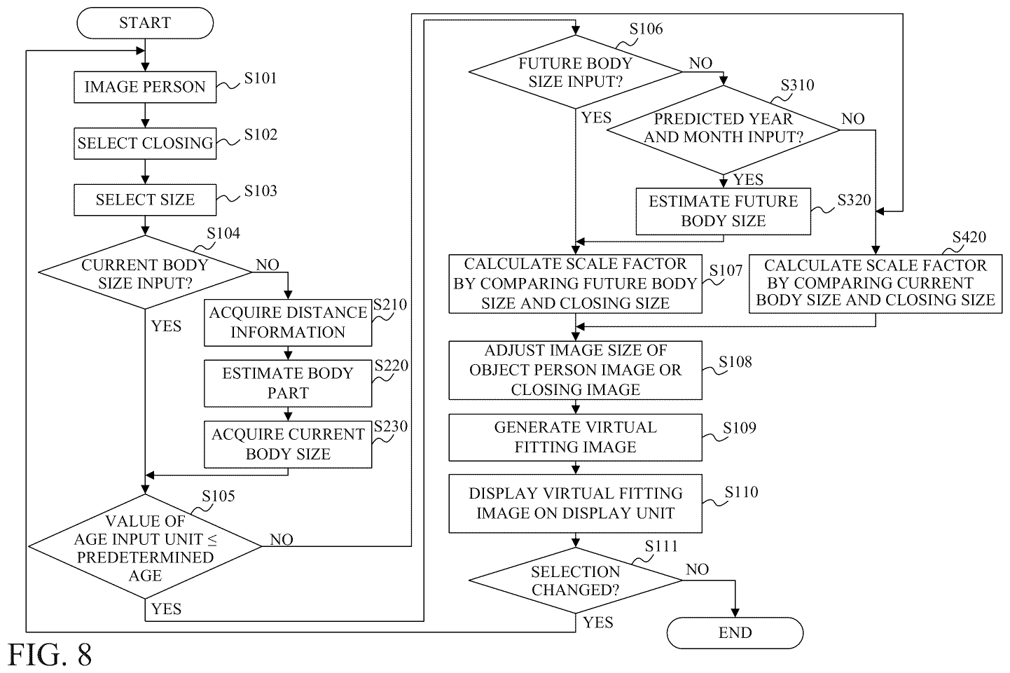

A detailed description will be given of the method by which the future body size acquiring unit 240 estimates the future body size. Referring now to FIGS. 3, 4A, and 4B, a description will be given of the method of estimating the future body size based on the current body size, age, predicted year and month, and probability distribution of the body size. FIG. 3 is a flowchart illustrating a procedure in which the future body size acquiring unit 240 estimates the future body size, and is the processing of step S320 in FIG. 8 relating to a processing method of the virtual fitting system 1000, which will be described later. FIGS. 4A and 4B are schematic diagrams of the body size for the processing of the future body size acquiring unit 240, and illustrate probability distributions of the body size stored in the statistical database 310.

First, in step S321 in FIG. 3, the future body size acquiring unit 240 reads from the statistical database 310 the probability distribution of body size that matches the age and gender of the object person input by the user via the input unit 120. Next, in step S322, the future body size acquiring unit 240 acquires the probability of the current body size in the called probability distribution. Although the method that is used at this time is not limited, for example, in FIG. 4A, where the horizontal axis represents the body size and the vertical axis represents the probability density, the area from the smallest body size to the current body size is calculated to obtain the probability.

Next, in step S323, the future body size acquiring unit 240 calls from the statistical data the probability distribution of the body size that matches the future age, which is the sum of the age and the predicted years and months, and the gender of the object person. Next, in step S324, the future body size acquiring unit 240 acquires the body size at the probability obtained in step S322 in the probability distribution called in step S323. For example, in a case where the probability is determined in step S322 as illustrated in FIG. 4A, the body size is calculated that gives the probability determined in step S322 from the smallest body size as illustrated in FIG. 4B. Then, in step S324, the future body size acquiring unit 240 outputs the acquired body size as the future body size.

This embodiment outputs the body sizes determined in step 323 as they are in step 324, but is not limited to this example, and may reflect some correction information on the body size from the user. For example, this embodiment may change the probability distribution to be called to upwardly revise the growth prediction in accordance with an individual's tendency, or allow a correction value for directly correcting each body size to be input via the input unit 120, and correct various body sizes in response to the input (girth +5%, inseam +4 cm, etc.).

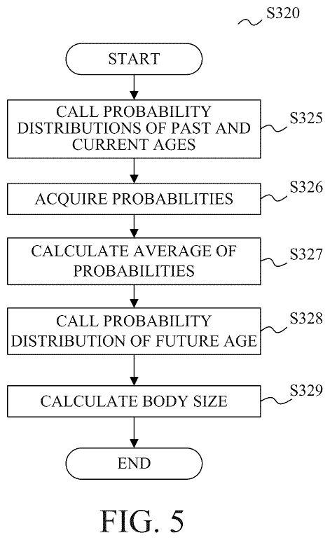

Referring now to FIG. 5, a description will be given of a method of estimating the future body size using the past body size. FIG. 5 is a flowchart illustrating a processing procedure in the future body size acquiring unit 240 in a case where the past body sizes are used. FIG. 5 illustrates the procedure for estimating the future body size using the past body size in the processing of step S320 in FIG. 8.

First, in step S325, in addition to the processing in step S321 of FIG. 3, the future body size acquiring unit 240 calls a probability distribution in which the age at each past body size acquired from the past body size input unit 125 matches the gender of the object person. In a case where a plurality of past body sizes are input, the probability distributions for all ages corresponding to them are called.

Next, in step S326, the future body size acquiring unit 240 acquires the probability of past body size in the probability distribution of each age, in addition to the processing in step S322, similarly to FIGS. 4A and 4B. In a case where a plurality of combinations of past body size and age, as in the example illustrated in step S322, the probability of past body size is obtained for each probability distribution of the age.

Next, in step S327, the future body size acquiring unit 240 calculates the probability by averaging the probability of the current body size acquired in step S326 and the probability of the past body size. Next, in step S328, the future body size acquiring unit 240 calls the probability distribution of body size that matches the future age and gender from the statistical database 310, similarly to step S323. Next, in step S329, the future body size acquiring unit 240 acquires the body size at the probability obtained in step S327 in the probability distribution called in step S328, similarly to step S324. The future body size acquiring unit 240 outputs the body size calculated in step S329 as the future body size. This embodiment calculates the average probability in step S327, but this embodiment is not limited to this example. Also, in step S329, correction may be performed based on correction information from the user, similarly to step S324.

The age corresponding to the current age and past body size that are used in the processing of the future body size acquiring unit 240 is one input by the user based on the birthday of the object person. However, in a case where the premature birth information input unit 127 has an input, the future body size acquiring unit 240 calculates the corrected age using the expected birth date as the birthday, and replaces the age input in the age input unit 123 and past body size input unit 125 with the corrected age. For example, in a case where the current age obtained from the age input unit 123 is 0 years and 8 months and the expected delivery date obtained from the premature birth information input unit 127 is two months after the birthday, the age is replaced with the current corrected age of 0 years and 6 months. For the age corresponding to the past body size and the future age, the corrected age is calculated by subtracting a difference of two months between the expected delivery date and the birthday. The future body size acquiring unit 240 estimates the future body size using the thus replaced corrected age.

Although the above method for estimating the future body size uses the probability distribution of the body size, this embodiment is not limited to this example. For example, estimation may use machine learning. The input unit 120 is not limited to this example, and a weight input unit for inputting the weight of the object person may be provided, and the future body size may be estimated using the weight as well.

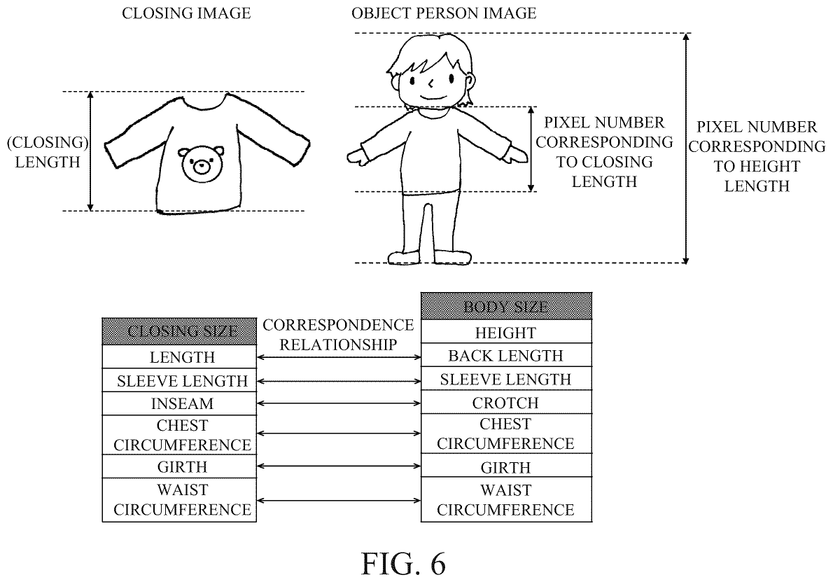

Referring now to FIG. 6, a detailed description will be given of the processing of the image adjuster 250. FIG. 6 explains the processing of the image adjuster 250. The image adjuster 250 adjusts (changes) the scale of at least one of the clothing image and the object person image. In FIG. 6, the scale of the clothing image is adjusted. In a case where the image adjuster 250 adjusts (changes) the scale of the clothing image, the scale factor is calculated using the following equation (1) using the future body size, the image size of the object person image, the clothing size, and the image size of the clothing image.

scale factor=(clothing size×image size of object person image)/(image size of clothing image×future body size) (1)

The image size is the size of the image itself, and may be expressed as the number of pixels, for example. The above calculation will be described using a specific example illustrated in FIG. 6. The upper left of FIG. 6 is an image of a T-shirt, which is clothing, and the upper right is an image of an object person, and it is assumed that both images are displayed at the same scale as the image size. In the example of FIG. 6, the clothing size for calculating the scale factor is set to the length of the T-shirt (the length of the clothing size), and the image size of the clothing image is acquired from the image size corresponding to the length of the T-shirt (the image size corresponding to the length of the clothing image). In addition, the future body size is set to the height (future height) of the future body size of the object person, and the image size of the object person image is acquired from the image size corresponding to the height of the object person (image size corresponding to the height of the person image). Therefore, the scale factor is calculated using the following equation (2).

scale factor=(length of clothing size×image size corresponding to height of person image)/(image size corresponding to length of clothing image×future height) (2)

In a case where the image adjuster 250 calculates the scale factor, any type of clothing size and future size may be selected. However, the image size of a clothing image is set to the image size of a part corresponding to a type selected in the clothing size, and the image size of an object person image is set to the image size of a part corresponding to the type selected in the future body size. Using the scale factor calculated in this way, the scale of the clothing image can be adjusted. That is, the adjusted image size of the clothing image is calculated using the following equation (3).

adjusted image size of clothing image=image size of clothing image×scale factor (3)

The scale factor may be calculated based on representative one of the types of clothing size and future body size, or may be calculated, as illustrated in a table at the bottom in FIG. 6, by associating the closing size and the future body size. In the example in which a scale factor is calculated using representative one of the types of clothing size and future body size, the image size of the entire clothing image is adjusted using the scale factor calculated by equation (2). On the other hand, in the example in which the scale factor is calculated by associating clothing size and a type of future body size, as illustrated in the table at the bottom in FIG. 6, the scale factor that has been calculated based on the length of the closing size and the back length of the body size in a correspondence relationship is used to adjust the image size corresponding to the length of the clothing image. The calculation of the scale factor using equation (2) and the processing of adjusting the image size using equation (3) are performed for sleeve length, inseam, chest circumference, girth, and waist circumference.

Although the image size of the clothing image is adjusted in the above examples, the image size of the object person image may be adjusted. In that case, the equation for the scale factor is expressed as the following equation (4) by replacing the denominator and numerator in equation (1).

scale factor=(image size of clothing image×future body size)/(clothing size×image size of object person image) (4)

The adjusted image size of the object person image can be calculated using the following equation (5) using the scale factor of equation (4).

adjusted image size of object person image=image size of object person image×scale factor (5)

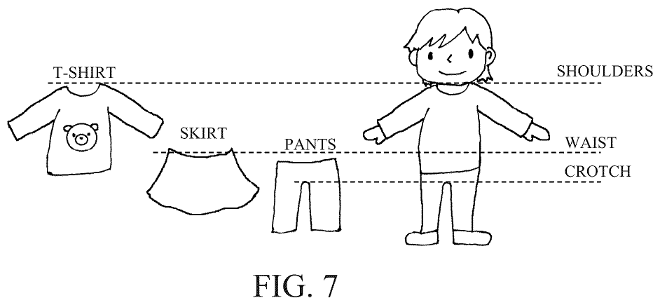

Referring now to FIG. 7, a detailed description will be given of the processing of the image generator 260. FIG. 7 explains the processing of the image generator 260. As illustrated in FIG. 7, the image generator 260 generates a combined image by superimposing a clothing image on an object person image based on the positions of the body parts. For example, a T-shirt is combined with the position of the object's shoulders, pants are combined with the crotch position, and a skirt is combined with the waist position.

Referring now to FIG. 8, a description will be given of the processing method of the virtual fitting system 1000. FIG. 8 is a flowchart illustrating the processing procedure of the virtual fitting system 1000.

First, in step S101, the virtual fitting system 1000 images an object person with the camera 110 and acquires an object person image. Next, in step S102, clothing selector 130 selects clothing. Here, the user selects clothing from the clothing database 320. Next, in step S103, the clothing selector 130 selects one of the sizes in the clothing selected by the user in step S102. Next, in step S104, the virtual fitting system 1000 determines whether or not a current body size is input in the current body size input unit 122 of the user terminal 100. In a case where it is determined that the current body size is input, the flow proceeds to step S105. On the other hand, in a case where it is determined that no current body size is input, the flow proceeds to step S210.

In step S210, the distance information acquiring unit 210 acquires three-dimensional distance information on the object person. Next, in step S220, the body part estimator 220 estimates the body part of the object person in the object person image. Next, in step S230, the current body size acquiring unit 230 calculates (acquires) the current body size. Then, the flow proceeds to step S105.

In step S105, the virtual fitting system 1000 determines whether the age input to the age input unit 123 is equal to or less than the predetermined age. In a case where it is determined that the input age is equal to or less than the predetermined age, the flow proceeds to step S106. On the other hand, in a case where it is determined that the input age is not equal to or less than the predetermined age, the flow proceeds to step S420.

In step S106, the virtual fitting system 1000 determines whether or not the future body size input unit 126 receives an input of the future body size. In a case where it is determined that the future body size has been input, the flow proceeds to step S107. On the other hand, in a case where it is determined that the future body size has not been input, the flow proceeds to step S310.

In step S310, the virtual fitting system 1000 determines whether the predicted year and month are input to the predicted year and month input unit 121. In a case where it is determined that the predicted year and month have been input, the flow proceeds to step S320. In step S320, the future body size acquiring unit 240 estimates the future body size of the object person the predicted years and months after the present time. Next, in step S107, the image adjuster 250 calculates the scale factor using equation (1) or (4), and the flow proceeds to step S108.

On the other hand, in a case where it is determined in step S310 that the predicted year and month have not been input to the predicted year and month input unit 121, the flow proceeds to step S420. The predicted year and month are not input in a case where the user wishes to check the virtual fitting state of the clothing on the current object person. In step S420, the virtual fitting system 1000 calculates a scale factor by replacing the future body size in equation (1) or (4) with the current body size, assuming that the predicted year and month are zero, and the flow proceeds to step S108.

In step S108, the image adjuster 250 adjusts the image size of the object person image or clothing image using equation (3) or (5) based on the scale factor calculated in step S107 or S420. Next, in step S109, the image generator 260 generates a virtual fitting image in which the clothing image is combined with the object person image. Next, in step S110, the virtual fitting system 1000 displays the virtual fitting image on the display unit 140. Next, in step S111, the virtual fitting system 1000 determines whether there is an input or selection change in the input unit 120 or clothing selector 130. In a case where it is determined that there is a change in input or selection, the flow proceeds to step S101. On the other hand, in a case where it is determined that there is no change in input or selection, this process ends.

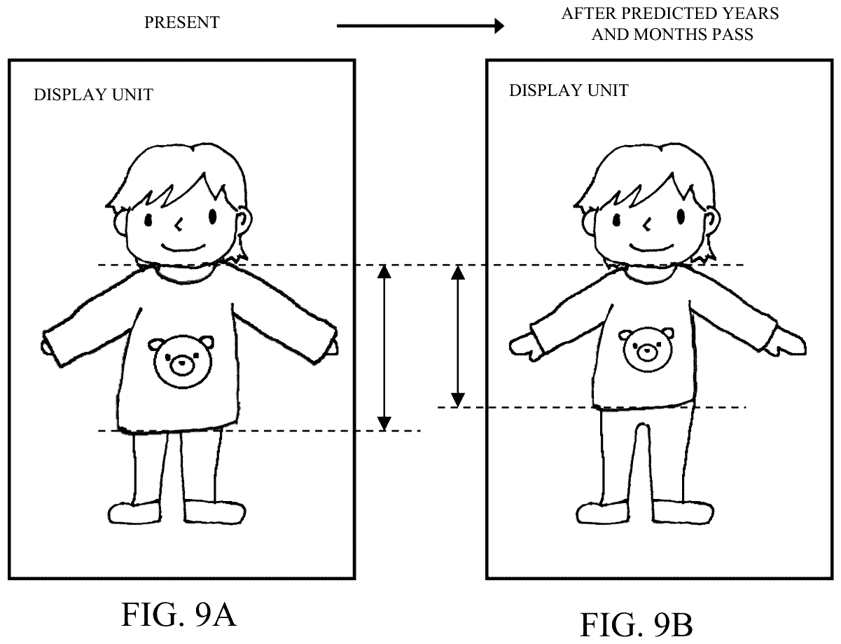

Referring now to FIGS. 9A and 9B, a description will be given of the effects of the virtual fitting system 1000. FIGS. 9A and 9B are schematic diagrams of virtual fitting images generated by the virtual fitting system 1000. In the virtual fitting system 1000, in a case where the virtual fitting image is generated on a route passing through step S420 in FIG. 8, the fitting image is as illustrated in FIG. 9A. In a case where there is an input to the predicted year and month input unit 121 and the virtual fitting image is generated on the route passing through step S107, the virtual fitting image will be as illustrated in FIG. 9B. In the example illustrated in this figure, the image adjuster 250 adjusts the scale of the clothing image.

First, FIG. 9A will be explained. As described with reference to FIG. 8, in a case where the age is not equal to or less than the predetermined age in step S105, the display on the display unit 140 is as illustrated in FIG. 9A. In a case where the object person is not equal to or less than the predetermined age, it is determined that there is no need for growth prediction, and a virtual fitting image is generated using the current body size of the object person and presented to the user. In a case where there is no input from the predicted year and month input unit 121 in step S310, the display is similarly as illustrated in FIG. 9A. Thereby, the user can check the virtual fitting state of the current object person.

Next, FIG. 9B will be explained. In calculating the scale factor using equation (1) in the image adjuster 250, the scale factor calculated using the future body size is smaller than the scale factor calculated using the current body size because the future body size is larger than the current body size. Therefore, the clothing image in FIG. 9B is smaller than that in FIG. 9A. Prior art illustrated in FIG. 9A enables the user to check the current “fitting state” of the current object person. On the other hand, the virtual fitting system 1000 according to this embodiment enables, as illustrated in FIG. 9B, the user to visually confirm the fitting state of the object person after the predicted years and months pass. Furthermore, the virtual fitting system 1000 can correct the image by the user input so that the user can more accurately predict the appearance after the predicted years and months pass.

The virtual fitting images in each example will be explained below.

### Example 1

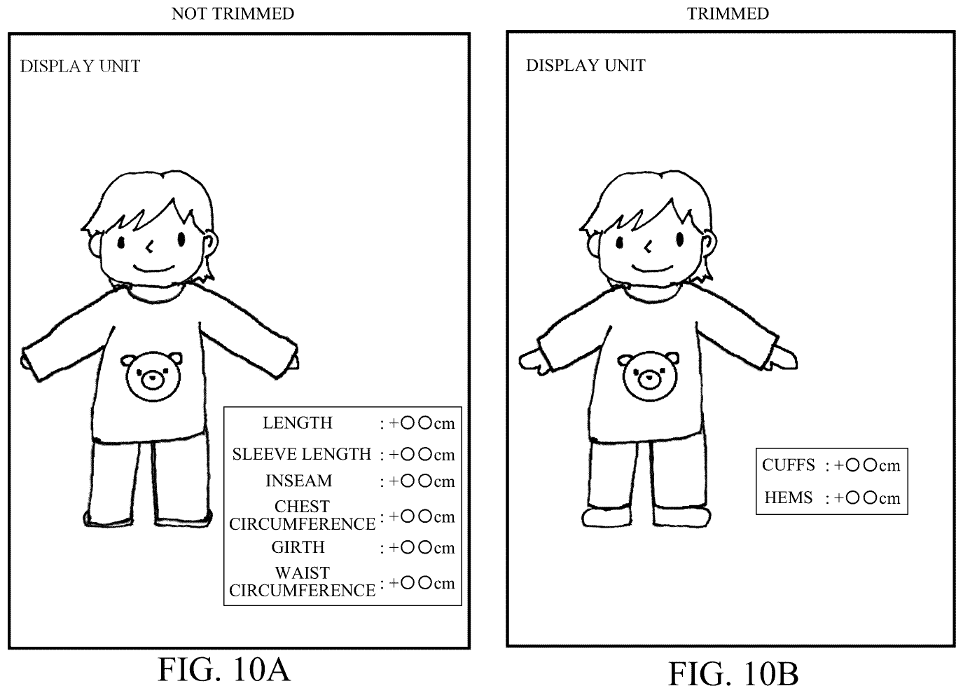

Referring now to FIG. 10A, a description will be given of the virtual fitting image according to Example 1. FIG. 10A explains a display method on the display unit 140 in the virtual fitting system 1000 according to this example. An unillustrated calculator in the virtual fitting system 1000 subtracts the future body size from the clothing size in the route passing through step S107 in FIG. 8, subtracts the current body size from the clothing size in the route passing through step S420, and displays the calculation result on the display unit 140. This display enables the user to check how big the clothing selected by the object person in the clothing selector 130 is or will be, and assists the user in deciding whether to purchase the clothing.

### Example 2

Referring now to FIG. 10B, a description will be given of a virtual fitting image according to Example 2. FIG. 10B explains a display method on the display unit 140 in the virtual fitting system 1000 according to this example. In a case where the sleeve length of the clothing size in the clothing image is longer than the sleeve length of the object person, the image adjuster 250 trims the cuffs so that the sleeve length of the clothing size in the clothing image is equal to the sleeve length of the object person. In addition, the display unit 140 displays length obtained by subtracting the sleeve length of the object person from the sleeve length of the clothing size in the clothing image, and informs the user of a difference in sleeve length. Similarly, in a case where the inseam of the closing size is longer than the inseam of the object person, the image adjuster 250 trims the hems so that the inseam of the closing is equal to the inseam of the object person. Then, the display unit 140 displays length obtained by subtracting the inseam of the object person from the inseam of the clothing size to inform the user of a difference in inseam. This display enables the user to check how much the cuffs and hems are to be folded back in a case where the object wears the clothing of the size selected in the clothing selector 130, and assists the user in deciding whether to purchase the clothing.

In each example, an object person image captured by the camera 110 may be a still image or a moving image, or a real-time moving image. The virtual fitting system 1000 may provide the user with audio guidance or display guidance on the display unit 140 in imaging an object person with the camera 110 so that the object person in the object person image falls within a predetermined range, faces a predetermined direction, and takes a predetermined pose. Thereby, the body size of the object person can be easily acquired and a virtual fitting image can be easily generated. Alternatively, the camera 110 may capture a moving image by providing guidance to the object person to make a predetermined motion, and then cut out a still or moving image when the object faces a desired orientation. In this case, although it is not a real-time moving image, the image generating apparatus 200 can more easily generate a virtual fitting image.

In each example, the clothing images in the clothing database 320 may be clothing images including three-dimensional models, and the clothing image may be combined with the object person so that the clothing follows the motion of the object person using a physical engine. Thereby, the user can confirm how the clothing changes when the object moves. For example, in a case where a T-shirt is selected in the clothing selector 130, the user can check whether the hem of the T-shirt lifts up when the object person raises her arms and her midriff is exposed.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

This embodiment can provide an image generating apparatus that enables a user to visually check a future fitting state.

This application claims priority to Japanese Patent Application No. 2023-126352, which was filed on Aug. 2, 2023, and which is hereby incorporated by reference herein in its entirety.

What is claimed is:

1. An image generating apparatus comprising:
a memory storing instructions; and
a processor configured to execute the instructions to:
compare a future body size of a person and a clothing size, and change a scale of at least one of a clothing image and a person image, and
generate a virtual fitting image by superimposing the clothing image on the person image.

2. The image generating apparatus according to claim 1, wherein the person image is acquired by imaging the person using an image pickup apparatus,
wherein the processor is configured to estimate the future body size using a current body size of the person, and
wherein the clothing size correspond to the clothing image obtained from a clothing database.

3. The image generating apparatus according to claim 1, wherein the processor acquires a current body size of the person.

4. The image generating apparatus according to claim 3, wherein the processor is configured to acquire three-dimensional distance information on the person.

5. The image generating apparatus according to claim 4, wherein the processor is configured to estimate a body part of the person in the person image, and to calculate the current body size based on an estimated body part and acquired distance information.

6. The image generating apparatus according to claim 5, wherein the body part includes at least one of a head, shoulder, hand, waist, crotch, and sole of a foot of the person.

7. The image generating apparatus according to claim 5, the processor is configured to generate the virtual fitting image by superimposing the clothing image on the person image based on the body part.

8. The image generating apparatus according to claim 2, wherein the processor is configured to estimate the future body size based on the current body size, age of the person, and predicted year and month of the person.

9. The image generating apparatus according to claim 1, wherein the future body size includes at least one of height, sleeve length, inseam, chest circumference, girth, and waist circumference of the person.

10. The image generating apparatus according to claim 1, wherein the clothing size includes at least one of length, sleeve length, inseam, chest circumference, girth, and waist circumference.

11. A virtual fitting system comprising:
the image generating apparatus according to claim 1; and
an image pickup apparatus configured to image the person and output the person image.

12. The virtual fitting system according to claim 11, further comprising a current body size input unit into which a current body size of the person is input.

13. The virtual fitting system according to claim 11, further comprising a gender input unit configured to acquire gender of the person.

14. The virtual fitting system according to claim 13, further comprising:
an age input unit configured to acquire age of the person;
a predicted year and month input unit configured to acquire predicted years and months of the person; and
a statistical database including a probability distribution of body size for men and women from birth to predetermined age,
wherein the processor is configured to estimate the future body size based on a current body size of the person, the age of the person, the predicted years and months of the person, and the probability distribution of the body size of the gender of the person.

15. The virtual fitting system according to claim 14, wherein the processor is configured to:
acquire a probability of the current body size based on the probability distribution of the body size for the age and the gender of the person, and
output, as the future body size, a body size at the probability in the probability distribution of a body size of the gender and future age obtained by adding the predicted years and months to the age.

16. The virtual fitting system according to claim 14, further comprising a past body size input unit into which a combination of a past body size of the person and age at that time are input,
wherein the processor is configured to estimate the future body size using the past body size acquired in a case where the past body size input unit has an input, and the age at that time.

17. The virtual fitting system according to claim 14, further comprising a premature birth information input unit configured to acquire information regarding whether or not the person is a premature baby, and an expected delivery date if the person is the premature baby,
wherein the processor is configured to calculate corrected age using the expected delivery date as a birthday, and to replace the age with the corrected age, in a case where the premature birth information input unit has an input.

18. The virtual fitting system according to claim 11, further comprising a future body size input unit into which the future body size of the person is input,
wherein in a case where the future body size input unit has an input, the processor is configured to set an input body size as the future body size.

19. The virtual fitting system according to claim 11, further comprising a display unit configured to display the virtual fitting image.

20. The virtual fitting system according to claim 11, further comprising a clothing database including data on a plurality of clothing images and clothing sizes corresponding to the plurality of clothing images.

21. The virtual fitting system according to claim 20, the processor is configured to:
select one of the plurality of clothing images in the clothing database,
select one size of a selected clothing image, and
adjust the scale of the image using a selected clothing size.

22. The virtual fitting system according to claim 21, the processor is configured to:
trim cuffs so that sleeve length of the clothing size is equal to sleeve length of the person in a case where it is determined that the sleeve length of the clothing size is longer than the sleeve length of the person, and
trim hems so that inseam of the clothing size is equal to inseam of the person in a case where it is determined that the inseam of the clothing size is longer than the inseam of the person.

23. The virtual fitting system according to claim 19, wherein the display unit displays length obtained by subtracting sleeve length of the person from sleeve length of the clothing size in a case where it is determined that the sleeve length of the clothing size is longer than the sleeve length of the person, and
wherein the display unit displays length obtained by subtracting inseam of the person from inseam of the clothing size in a case where it is determined that the inseam of the clothing size is longer than the inseam of the person.

24. The virtual fitting system according to claim 19, wherein the display unit displays size obtained by subtracting a future body size or a current body size from the clothing size.

25. An image generating method comprising the steps of:
compare a future body size of a person and a clothing size, and change a scale of at least one of a clothing image and a person image, and
generate a virtual fitting image by superimposing the clothing image on the person image.

26. A non-transitory computer-readable storage medium storing a program that causes a computer to execute the image generating method according to claim 25.
